(19) United States
(12) Patent Application Publication
(10) Pub. No.: US 2016/0370628 A1
(43) Pub. Date: Dec. 22, 2016

(54) DISPLAY SUBSTRATE, DISPLAY PANEL AND METHOD FOR FORMING PHOTO SPACER

(71) Applicants: Boe Technology Group Co., Ltd., Beijing (CN); Chongqing Boe Optoelectronics Technology Co., Ltd., Chongqing (CN)

(72) Inventor: Li Zhe, Beijing (CN)

(21) Appl. No.: 14/741,712

(22) Filed: Jun. 17, 2015

(51) Int. Cl. G02F 1/1339; G02F 1/1337; G02F 1/1335

(52) U.S. Cl. CPC G02F 1/13394; G02F 1/133514; G02F 1/133512; G02F 1/1337; G02F 2001/13398

(57) ABSTRACT

An embodiment of the present invention relates to the technical field of display, and provides a display substrate, a display panel and a method for forming a photo spacer, which may solve the problem of bad display caused by an uneven cell gap of a display panel due to relative sliding between photo spacers and pillows. The display substrate comprises a first substrate, as well as a first photo spacer disposed on one side of the first substrate. A first recess is disposed on a first surface, which is spaced apart from the first substrate, of the first photo spacer, the first recess allowing one end, which faces the first photo spacer, of a first pillow to extend into the first recess, wherein the first pillow is positioned on a second substrate in an alignment substrate aligned with the display substrate.

### RELATED APPLICATIONS

The present application claims the benefit of Chinese Patent Application No. 201410685605.9, filed Nov. 25, 2014, the entire disclosure of which is incorporated herein by reference.

### TECHNICAL FIELD

The present invention relates to the technical field of display, and particularly relates to a display substrate, a display panel and a method for forming a photo spacer.

### BACKGROUND ART

A liquid crystal display panel generally comprises an array substrate and a color film substrate which are aligned with each other, as well as a liquid crystal layer positioned between the above two substrates. During aligning the array substrate and the color film substrate, the uniformity of a cell gap of the liquid crystal display panel is kept generally by the following approach: as shown in FIG. 1A, a pillow 40 is disposed above gate lines of the array substrate, a photo spacer (referred to as PS) 30 in positional correspondence to the pillow 40 is disposed on the color film substrate, and through the lower surface of the PS propping against the upper surface of the pillow, it is ensured that the liquid crystal display panel has a certain cell gap.

However, during conveying and moving the liquid crystal display panel, under the action of an external force, as shown in FIG. 1B, the PS and the pillow may slide relatively to each other, that is, the upper surface of the pillow does not prop against the lower surface of the PS any more, thereby causing deformation of liquid crystal molecules filled between the array substrate and the color film substrate and finally causing problems of bad display and the like caused by an uneven cell gap in the liquid crystal display panel.

### SUMMARY OF THE INVENTION

In view of the above, to solve the problem of the prior art, an embodiment of the present invention provides a display substrate, a display panel and a method for forming a photo spacer, which may solve the problem of bad display caused by an uneven cell gap of a display panel due to relative sliding between photo spacers and pillows.

To achieve the above objective, the embodiment of the present invention employs the following technical solution:

According to one aspect, an embodiment of the present invention provides a display substrate. The display substrate comprises a first substrate. The display substrate further comprises a first photo spacer disposed on one side of the first substrate, and a first recess is disposed on a first surface, which is spaced apart from the first substrate, of the first photo spacer, the first recess allowing one end, which faces the first photo spacer, of a first pillow to extend into the first recess, wherein the first pillow is positioned on a second substrate in an alignment substrate aligned with the display substrate.

In an embodiment, the display substrate further comprises a second pillow positioned on the same side of the first substrate as the first photo spacer, the second pillow allowing one end thereof, which faces a second photo spacer, to extend into a second recess, wherein the second photo spacer is positioned on the second substrate, and the second recess is disposed on a first surface, which is spaced apart from the second substrate, of the second photo spacer.

In an embodiment, the first photo spacer is a post photo spacer.

In an embodiment, when the projection is performed along a direction perpendicular to the substrate surface of the first substrate, an area that the first surface of the first photo spacer is projected on the first substrate is less than or equal to an area that a second surface, which is spaced apart from the first surface, of the first photo spacer is projected on the first substrate.

According to another aspect, an embodiment of the present invention provides a display panel. The display panel comprises the above display substrate, as well as an alignment substrate aligned with the display substrate. The alignment substrate comprises a second substrate, as well as a first pillow disposed on one side, which faces the display substrate, of the second substrate, wherein one end, which faces the first photo spacer, of the first pillow is positioned in the first recess.

In an embodiment, along a direction perpendicular to the panel surface of the display panel, the depth of the first recess is less than the height of the first pillow.

In an embodiment, the display panel further comprises a second pillow positioned on the same side of the first substrate as the first photo spacer, and the alignment substrate further comprises a second photo spacer positioned on the same side of the second substrate as the first pillow, wherein a second recess is disposed on a first surface, which faces the second pillow, of the second photo spacer, and one end, which faces the second photo spacer, of the second pillow is positioned in the second recess.

In an embodiment, along a direction perpendicular to the panel surface of the display panel, the depth of the second recess is less than the height of the second pillow.

In an embodiment, the second photo spacer is a post photo spacer.

In an embodiment, when the projection is performed along a direction perpendicular to the substrate surface of the second substrate, an area that the first surface of the second photo spacer is projected on the second substrate is less than or equal to an area that a second surface, which is spaced apart from the first surface, of the second photo spacer is projected on the second substrate.

In an embodiment, the display substrate is a color film substrate, and the alignment substrate is an array substrate. The display substrate further comprises a black matrix positioned on the first substrate, wherein the first photo spacer is positioned above the black matrix. The alignment substrate further comprises a plurality of gate lines arranged in parallel on the second substrate, wherein the first pillow is positioned above the gate lines.

In an embodiment, the second pillow is positioned above the black matrix, and the second photo spacer is positioned above the gate lines.

According to yet another aspect, an embodiment of the present invention further provides a method for forming a photo spacer on a substrate. The method comprises: forming a photo spacer layer on a substrate, and patterning the photo spacer layer so as to form a photo spacer, wherein a recess is formed on a first surface, which is spaced apart from the substrate, of the photo spacer.

In an embodiment, the photo spacer layer is composed of a positive/negative photoresist material. The patterning particularly comprises: performing exposure and development on the substrate on which the photo spacer layer is formed by adopting a half-tone mask plate or gray-tone mask plate, so as to form a photo spacer fully-reserved portion, a photo spacer half-reserved portion and a photo spacer fully-removed portion. The photo spacer fully-reserved portion and the photo spacer half-reserved portion form the photo spacer. The photo spacer half-reserved portion corresponds to a first area, which is covered by the recess, in the photo spacer to be formed, the photo spacer fully-reserved part corresponds to other areas in the photo spacer to be formed except for the first area, and the space fully-removed portion corresponds to other areas in the photo spacer layer except for the photo spacer to be formed.

Based on this, in the above display substrate provided by the embodiment of the present invention, a depression structure (that is, the first recess) with a certain depth is formed on the first surface, which faces the alignment substrate, of the first photo spacer. After the display substrate is aligned with the alignment substrate, the first pillow falls into the first recess. Because this depression structure has a certain depth, for the display panel formed after the display substrate is aligned with the alignment substrate, the first pillow is hard to slide out from the first recess in the first photo spacer even if being subjected to larger external forces while conveying and moving. In this way, it is ensured that the first photo spacer always props against the first pillow, so that the display panel formed after alignment may not have the problem of bad display caused by an uneven cell gap of the display panel due to relative sliding of the photo spacers and the pillows as that in the prior art, thereby improving the product performance of the display panel formed after alignment, and reducing the probability of inspection and repairing.

### BRIEF DESCRIPTION OF THE DRAWINGS

In order to clearly illustrate the technical solution according to embodiments of the present invention or the prior art, the drawings used in describing embodiments of the present invention or the prior art will be briefly explained hereinafter. It is obvious that the drawings in the following description are only related to some embodiments of the present invention. Those of ordinary skilled in the art may also obtain other variations without any inventive work.

FIG. 1A is a schematic cross-sectional view of a liquid crystal display panel according to the prior art;

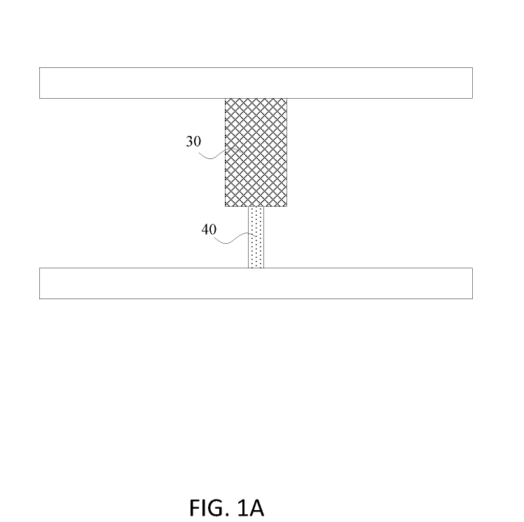

FIG. 1B is a schematic structural view of a liquid crystal display panel shown in FIG. 1A after photo spacers on a color film substrate and pillows on an array substrate slide relatively to each other;

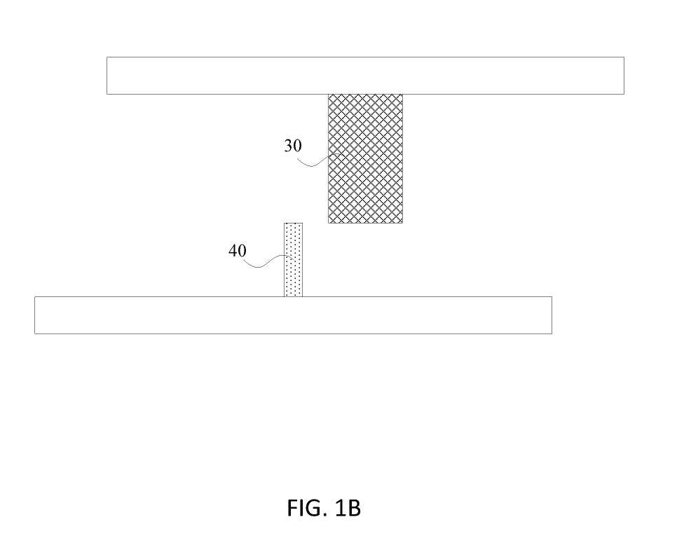

FIG. 2A is a schematic cross-sectional view of a display substrate according to an embodiment of the present invention;

FIG. 2B is a schematic cross-sectional view of an alignment substrate aligned with a display substrate shown in FIG. 2A;

FIG. 2C is a schematic cross-sectional view after a display substrate shown in FIG. 2A is aligned with an alignment substrate shown in FIG. 2B;

FIG. 2D is another schematic cross-sectional view of an alignment substrate aligned with a display substrate shown in FIG. 2A;

FIG. 2E is a schematic cross-sectional view after a display substrate shown in FIG. 2A is aligned with an alignment substrate shown in FIG. 2D;

FIG. 3A is an enlarged schematic view of a dotted portion in FIG. 2C;

FIG. 3B is another enlarged schematic view of a dotted portion in FIG. 2C;

FIG. 4A is another schematic cross-sectional view of a display substrate according to an embodiment of the present invention;

FIG. 4B is a schematic top view of a display substrate shown in FIG. 4A;

FIG. 5 is yet another schematic cross-sectional view of a display substrate according to an embodiment of the present invention;

FIG. 6 is a schematic cross-sectional view of a liquid crystal display panel according to an embodiment of the present invention; and

FIG. 7 is a specific schematic view of a step S02 in a method for forming a photo spacer on a substrate according to an embodiment of the present invention.

### LIST OF REFERENCE NUMERALS

01—liquid crystal display panel; 10—display substrate; 100—first substrate; 11—first photo spacer; 110—first surface of first photo spacer; 111—first recess; 112—second surface of first photo spacer; 12—second pillow; 20—alignment substrate; 200—second substrate; 21—first pillow; 210—first surface of first pillow; 211—second surface of first pillow; 22—second photo spacer; 221—second recess; 30—photo spacer; 31—photo spacer fully-reserved portion; 32—photo spacer half-reserved portion; 33—photo spacer fully-removed portion; 40—pillow

### DETAILED DESCRIPTION OF THE INVENTION

The technical solutions according to embodiments of the present invention will be described clearly and fully in connection with the drawings. It is obvious that the described embodiments are just a part but not all of the embodiments of the present invention. According to the embodiments of the present invention, all other embodiments which can be obtained by those of ordinary skilled in the art without any inventive work, should fall within the protective scope of the present invention.

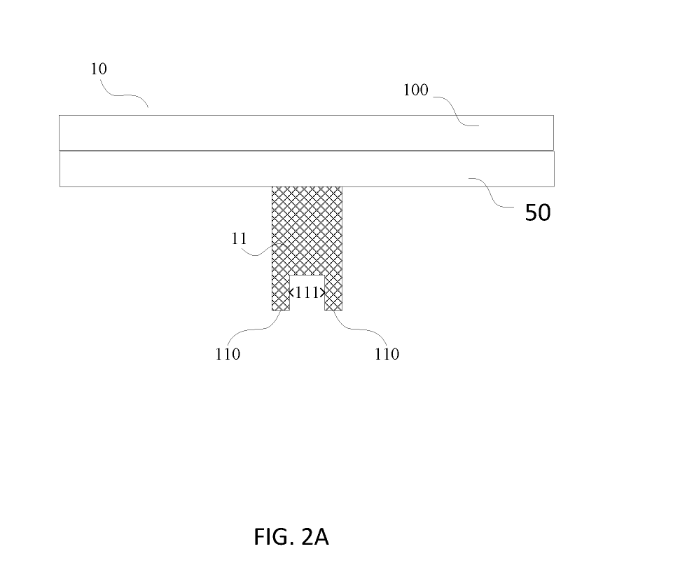

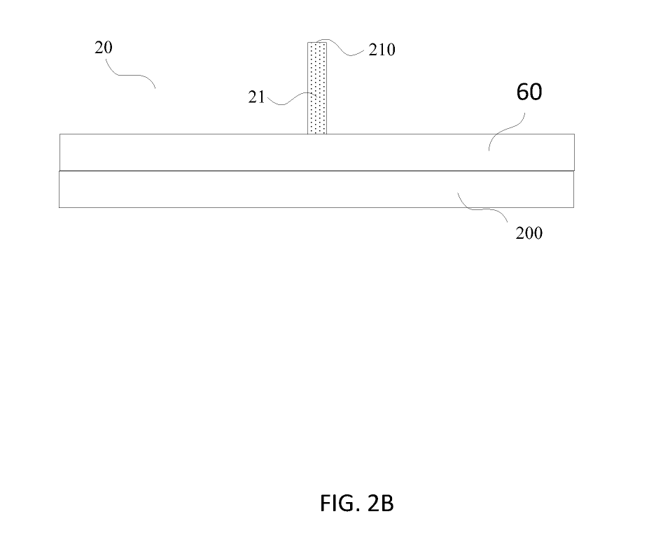

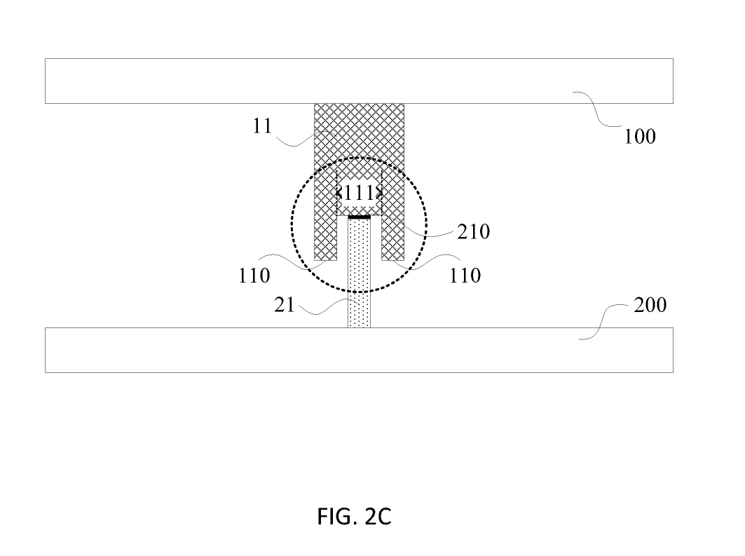

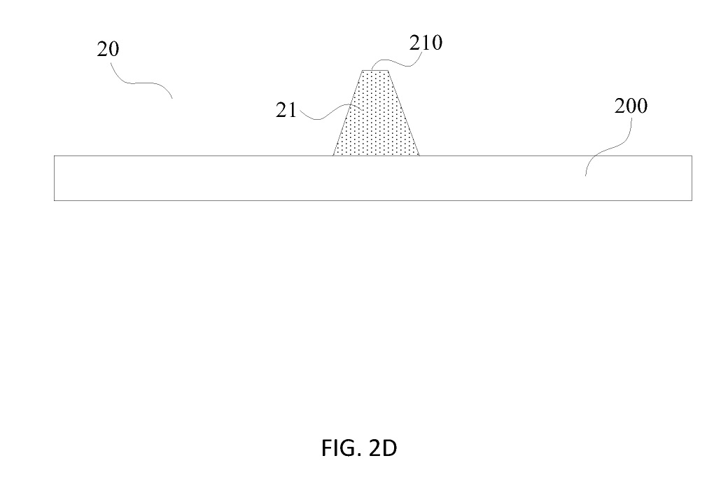

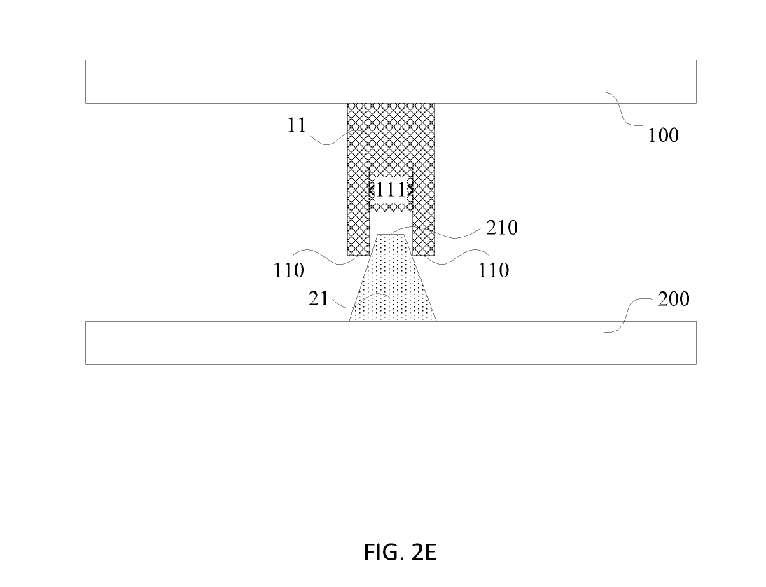

An embodiment of the present invention provides a display substrate 10. As shown in FIG. 2A, the display substrate 10 comprises a first substrate 100, as well as a first photo spacer 11 disposed on one side of the first substrate 100. A first recess 111 is disposed on a first surface 110, which is spaced apart from the first substrate 100, of the first photo spacer 11, and the first recess 111 allows one end, which faces the first photo spacer 11, of a first pillow 21 to extend into the first recess 111, wherein as shown in FIG. 2B or FIG. 2D, the first pillow 21 is positioned on a second substrate 200 in an alignment substrate 20 aligned with the display substrate 10.

It should be noted that, firstly, for an expression “the first recess 111 allows one end, which faces the first photo spacer 11, of a first pillow 21 to extend into the first recess 111”, it will be particularly explained as follows. A depression structure, that is, the first recess 111, is formed on the first surface 110, as exemplarily shown in FIG. 2C. As such, in a case where the opening width of the first recess 111 is greater than the maximum cross section of the first pillow 21—for example, when the first pillow 21 is a cylinder structure with the upper width and the lower width thereof equal to each other, it is a case where the opening width of the first recess 111 is greater than the width of a first surface 210 of the first pillow 21—the first pillow 21 falls into this depression structure and the first surface 210 thereof props against the first recess 111 after the display substrate 10 (not shown in FIG. 2C) is aligned with the alignment substrate 20 (not shown in FIG. 2C), thereby limiting relative sliding of the first photo spacer 11 and the first pillow 21.

Here, there are no particular requirements regarding a cross-section shape (which for example may be a rectangle, a circle, an ellipse, a polygon and the like), a cross-section width and a depth of the first recess 111, as long as one end, which faces the first recess 111, of the first pillow 21 is enabled to extend into the first recess 111 and relative sliding between the first photo spacer 11 and the first pillow 21 is limited.

In addition, for example, it may be a case where one part of the first pillow 21 extends into the first recess 111, as shown in FIG. 2C, or another one where the entire first pillow 21 extends into the first recess 111.

Alternatively, as exemplarily shown in FIG. 2E, when the opening area of the first recess 111 is greater than that of the first surface 210 of the first pillow 21 but less than that of a bottom surface, which is spaced apart from the first surface 210, of the first pillow 21, that is, when the first pillow 21 is a trapezoidal-cylinder structure, because the first recess 111 allows one end, which faces the first photo spacer 11, of the first pillow 21 to extend into the first recess 111, this particular one end of the first pillow 21 may be stuck into the first recess 111 after the display substrate 10 (not shown in FIG. 2C) is aligned with the alignment substrate 20 (not shown in FIG. 2C), so that the limitation of relative sliding between the first photo spacer 11 and the first pillow 21 is also achieved.

Secondly, there are no particular requirements regarding the display substrate 10 and the alignment substrate 20. One of the display substrate 10 and the alignment substrate 20 may be a color film substrate in the display panel, and the other may be an array substrate aligned with the color film substrate.

Here, in a case where the display substrate 10 is the color film substrate and correspondingly the alignment substrate 20 is the array substrate, the display substrate 10 may further comprise, for example, a black matrix, a color filter layer and other structures, which are disposed on the first substrate 100, and the alignment substrate 20 may further comprise, for example, a hierarchical structure of a thin film transistor (referred to as TFT), a pixel electrode, a passivation layer, a common electrode and other structures; vice versa.

Based on this, in the above display substrate 10 provided by the embodiment of the present invention, a depression structure (that is, the first recess 111) with a certain depth is formed on the first surface 110 (which faces the alignment substrate 20) of the first photo spacer 11. After the display substrate 10 is aligned with the alignment substrate 20, the first pillow 21 falls into the first recess 111. Because this depression structure has a certain depth, for the display panel (liquid crystal display panel in this embodiment) formed after the display substrate 10 is aligned with the alignment substrate 20, the first pillow 21 is hard to slide out from the first recess 111 in the first photo spacer 11 even if being subjected to larger external forces while conveying and moving. In this way, it is ensured that the first photo spacer 11 always props against the first pillow 21, so that the liquid crystal display panel formed after alignment may not have the problem of bad display caused by an uneven cell gap of the liquid crystal display panel due to relative sliding of the photo spacers and the pillows as that in the prior art, thereby improving the product performance of the liquid crystal display panel formed after alignment, and reducing the probability of inspection and repairing.

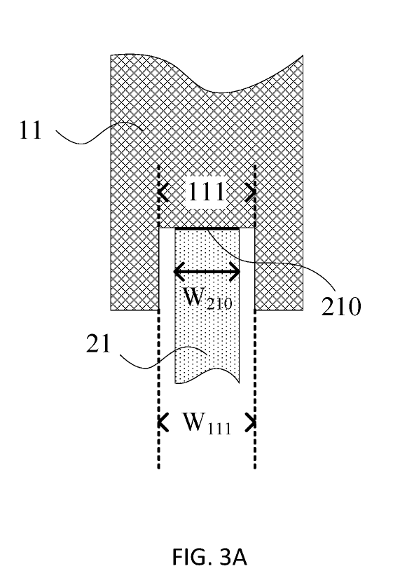

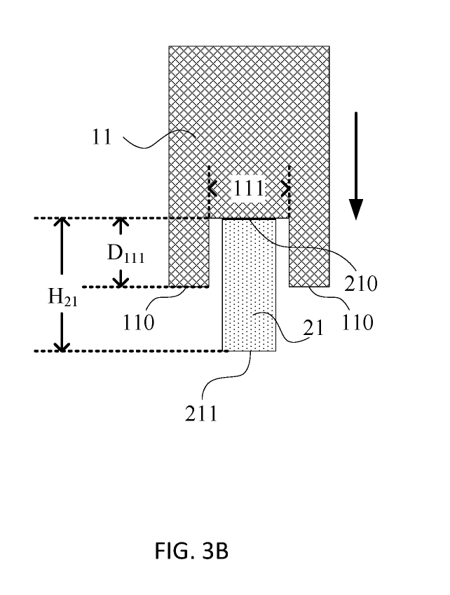

Further, as shown in FIG. 3A, in a cross section perpendicular to the display substrate, the opening width (all marked as W₁₁₁ in the drawing and hereafter) of the first recess 111 is greater than the maximum width of the first pillow 21. For example, when the first pillow 21 is a cylinder structure with the upper width and the lower width thereof equal to each other, the opening width of the first recess 111 is greater than the width (all marked as W₂₁₀ in the drawing and hereinafter) of the first surface 210, which faces the first photo spacer 11, of the first pillow 21.

In this way, in contrast to the above structure shown in FIG. 2E, when the opening width W₁₁₁ of the first recess 111 is greater than the maximum width of the first pillow 21, for example, greater than the width W₂₁₀ of the first surface 210, which faces the first photo spacer 11, of the first pillow 21, the first pillow 21 extends into the first recess 111 after the display panel 10 is aligned with the alignment substrate 20, thus propping against the first recess 111 more stably.

Further, the width W₁₁₁ may be just slightly greater than the width W₂₁₀. In this way, for the liquid crystal display panel formed after alignment, the first pillow 21 is hard to slide out from the first recess 111 in the first photo spacer 11 even if being subjected to larger external forces, so that the stability after the display panel 10 is aligned with the alignment substrate 20 is further improved.

Further, as shown in FIG. 3B, along a direction (as shown by an arrow in the drawing) perpendicular to the panel surface of the liquid crystal display panel, the depth of the first recess 111 (all marked as D₁₁₁ in the drawing and hereinafter) is less than the height (all marked as H₂₁ in the drawing and hereinafter) of the first pillow 21.

Herein, only the first photo spacer 11 and the first pillow 21 are shown in the drawing. And, the depth D₁₁₁ is less than the height H₂₁, that is, there is a certain height difference between the first surface 110, which faces the first pillow 21, of the first photo spacer 11 and a second surface 211, which is spaced apart from the first surface 210 propping against the first recess 111, of the first pillow 21. In this way, when the liquid crystal display panel formed after the display panel 10 is aligned with the alignment substrate 20 is subjected to a vertical external force in a direction as indicated by an arrow in the drawing or its reverse direction, a certain margin may be provided for buffering the vertical external force, so that the stability after the display panel 10 is aligned with the alignment substrate 20 is further improved.

Based on the above, with reference to FIG. 2A as well as FIG. 2C to FIG. 3B, in an embodiment, the first photo spacer 11 may be a post photo spacer.

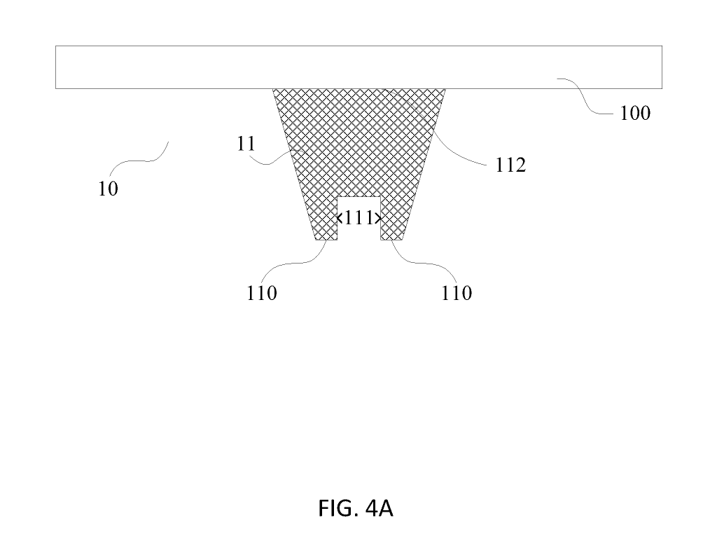

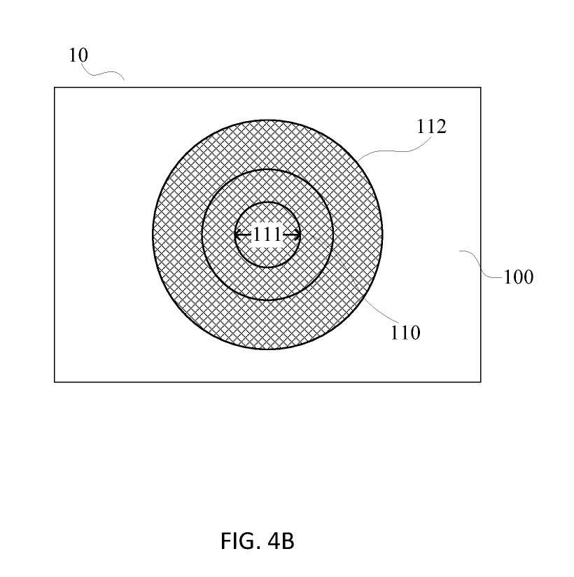

Further, as shown in FIG. 4A and FIG. 4B, when the projection is performed along a direction perpendicular to the substrate surface of the first substrate 100, an area that the first surface 110 of the first photo spacer 11 is projected on the first substrate 100 is less than or equal to an area that a second surface 112, which is spaced apart from the first surface 110, of the first photo spacer 11 is projected on the first substrate 100.

Here, for the sake of simplicity, FIG. 4B only schematically illustrate a case where shapes of the first recess 111, the upper surface 110 and the lower surface 112 projected on the first substrate 100 are all circles, but shapes of the above three structures projected on the first substrate 100 are not limited to this.

In this way, if the liquid crystal display panel formed after the display panel 10 is aligned with the alignment substrate 20 is subjected to a vertical external force in a direction as indicated by an arrow in FIG. 3B or its reverse direction, and the external force is so large that the first photo spacer 11 is compressed in a direction perpendicular and pointing to the substrate surface of the first substrate 100, because the area that the first surface 110 of the first photo spacer 11 is projected on the first substrate 100 is less than or equal to the area that the second surface 112, which is spaced apart from the first surface 110, of the first photo spacer 11 is projected on the first substrate 100, the second surface 112 with a larger area may make the stress better dispersed into the first substrate 100, so that the external force withstood by the liquid crystal display panel formed after alignment is reduced.

Further, with reference to FIG. 4B, when the projection is performed along a direction perpendicular to the substrate surface of the first substrate 100, a shape that the first surface 100 of the first photo spacer 11 is projected on the first substrate 100 and a shape that the second surface 112, which is spaced apart from the first surface 110, of the first photo spacer 11 is projected on the first substrate 100 are any of a rectangle, a circle and a ellipse.

Here, in view of simplicity of a fabricating process, shapes that the first surface 110 and the second surface 112 are projected on the first substrate 100 are the same.

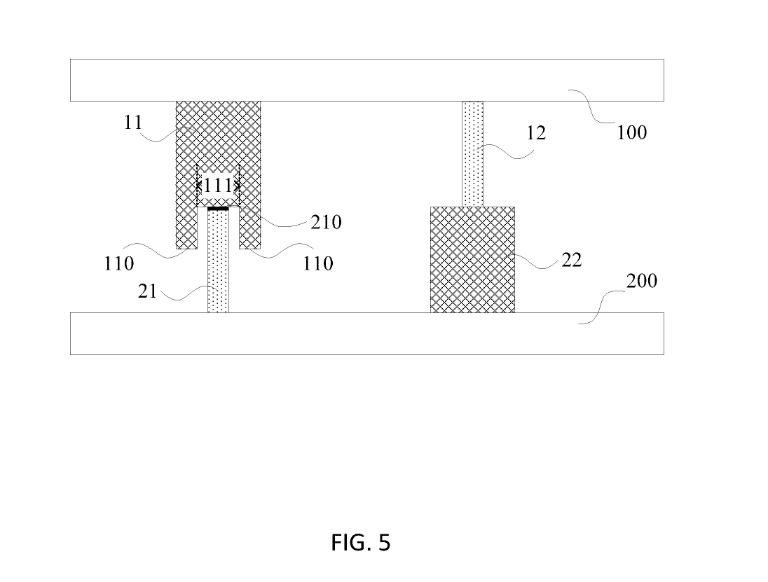

Based on the above, as shown in FIG. 5, the display substrate 100 (not shown in FIG. 5) may be aligned with the alignment substrate 20 (not shown in FIG. 5) in an interactive manner. That is, the display substrate 10 further comprises a second pillow 12 positioned on the same side of the first substrate 100 as the first photo spacer 11, and the second pillow 12 allows one end thereof, which faces a second photo spacer 22, to extend into a second recess, wherein the second photo spacer 22 is positioned on the second substrate 200, and the second recess is disposed on a first surface, which is spaced apart from the second substrate, of the second photo spacer.

In this way, it is enabled that forces between the first photo spacer 11 and the first pillow 21 as well as between the second pillow 12 and the second photo spacer 22 are uniformly dispersed on the display substrate 10 and the alignment substrate 20, thereby ensuring that the liquid crystal display panel formed after alignment withstands the external force more stably.

An embodiment of the present invention further provides a display panel 01, particularly a liquid crystal display panel. With reference to FIG. 2C, the liquid crystal display panel comprises a display substrate 10, as well as an alignment substrate 20 aligned with the display substrate 10. The alignment substrate 20 comprises a second substrate 200, as well as a first pillow 21 disposed on one side, which faces the display substrate 10, of the second substrate 200, wherein one end, which faces the first photo spacer 11, of the first pillow 21, is positioned in the first recess 111.

Based on this, because one end, which faces the first photo spacer 11, of the first pillow 21, is positioned in the first recess 111, for the liquid crystal display panel formed after the display substrate 10 is aligned with the alignment substrate 20, the first pillow 21 is hard to slide out from the first recess 111 in the first photo spacer 11 even if being subjected to larger external forces while conveying and moving. In this way, it is ensured that the first photo spacer 11 always props against the first pillow 21, so that the liquid crystal display panel formed after alignment may not have the problem of bad display caused by an uneven cell gap of the liquid crystal display panel due to relative sliding of the photo spacers and the pillows as that in the prior art, thereby improving the product performance of the liquid crystal display panel formed after alignment, and reducing the probability of inspection and repairing.

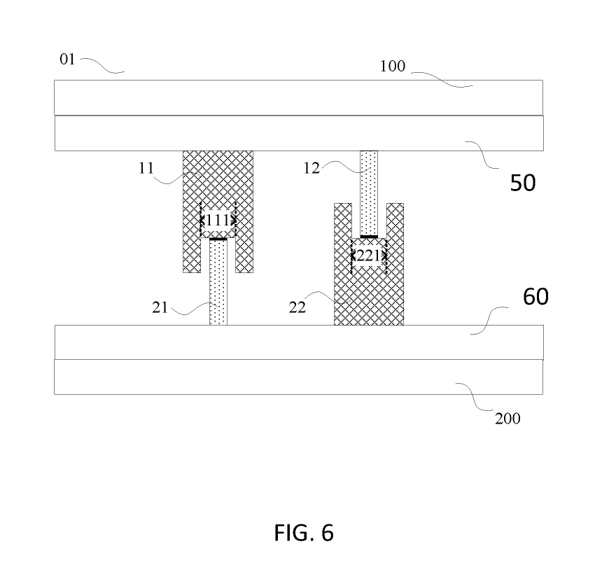

Based on the above, as shown in FIG. 6, the display substrate 10 further comprises a second pillow 12 positioned on the same side of the first substrate 100 as the first photo spacer 11, and the alignment substrate 20 further comprises a second photo spacer 22 positioned on the same side of the second substrate 200 as the first pillow 21, wherein a second recess 221 is disposed on a first surface, which faces the second pillow 12, of the second photo spacer 22, and one end, which faces the second photo spacer 22, of the second pillow 12 is positioned in the second recess 221.

In this way, since the first photo spacer 11 and the first pillow 21, the second photo spacer 22 and the second pillow 12 which are respectively positioned on the display substrate 10 and the alignment substrate 20 form an interactive snap-in structure, forces between the first photo spacer 11 and the first pillow 21 as well as between the second pillow 12 and the second photo spacer 22 are uniformly dispersed on the display substrate 10 and the alignment substrate 20, so that the liquid crystal display panel formed after alignment may not have the problem of bad display caused by an uneven cell gap of the liquid crystal display panel due to relative sliding of the photo spacers and the pillows as that in the prior art,

Further, with reference to FIG. 3A, in a cross section perpendicular to the liquid crystal display panel, along a direction parallel to the substrate surface of the second substrate 200, the opening width of the second recess 221 is greater than the maximum width of the second pillow 12.

Further, the opening width of the second recess 221 may be just slightly greater than the width of a first surface, which faces the second photo spacer 22, of the second pillow 12. In this way, for the liquid crystal display panel formed after alignment, the second pillow 12 is hard to slide out from the second recess 221 in the second photo spacer 22 even if being subjected to larger external forces, so that the stability after the display panel 10 is aligned with the alignment substrate 20 is further improved.

Further, with reference to FIG. 3B, along a direction perpendicular to the panel surface of the liquid crystal display panel, the depth of the second recess 221 is less than the height of the second pillow 12.

In this way, when the liquid crystal display panel formed after the display panel 10 is aligned with the alignment substrate 20 is subjected to a vertical external force in a direction as indicated by an arrow in FIG. 3B or its reverse direction, a certain margin may be provided for buffering the vertical external force, so that the stability after the display panel 10 is aligned with the alignment substrate 20 is further improved.

Based on the above, with reference to FIG. 2A as well as FIG. 2C to FIG. 3B, in an embodiment, the second photo spacer 22 may be a post photo spacer.

Further, as shown in FIG. 4A and FIG. 4B, when the projection is performed along a direction perpendicular to the substrate surface of the second substrate 200, an area that the first surface of the second photo spacer 22 is projected on the second substrate 200 is less than or equal to an area that a second surface, which is spaced apart from the first surface, of the second photo spacer 22 is projected on the second substrate 200.

In this way, if the liquid crystal display panel formed after the display panel 10 is aligned with the alignment substrate 20 is subjected to a vertical external force in a direction as indicated by an arrow in FIG. 3B or its reverse direction, and the external force is so large that the second photo spacer 22 is compressed in a direction perpendicular and pointing to the substrate surface of the second substrate 200, because the area that the first surface of the second photo spacer 22 is projected on the second substrate 200 is less than or equal to the area that the second surface, which is spaced apart from the first surface, of the second photo spacer 22 is projected on the second substrate 200, the second surface with a larger area may make the stress better dispersed into the second substrate 200, so that the external force withstood by the liquid crystal display panel formed after alignment is reduced.

Further, with reference to FIG. 4B, when the projection is performed along a direction perpendicular to the substrate surface of the second substrate 200, a shape that the first surface of the second photo spacer 22 is projected on the second substrate 200 and a shape that the second surface, which is spaced apart from the first surface, of the second photo spacer 22 is projected on the second substrate 200 are any of a rectangle, a circle and an ellipse.

Here, in view of simplicity of a fabricating process, shapes that the first surface and the second surface are projected on the second substrate 200 are the same.

Based on the above, in view of relatively less structures on a color film substrate and relatively large volume of the photo spacers relative to the pillows, in order to balance the thickness difference between the color film substrate and the array substrate, the display substrate 10 acts as the color film substrate and the alignment substrate 20 acts as the array substrate. The display substrate 10 further comprises a black matrix positioned on the first substrate 100, wherein the first photo spacer 11 is positioned above the black matrix, thereby reducing the occupation of an effective display area of the liquid crystal display panel and ensuring that the liquid crystal display panel has an opening ratio as big as possible. The alignment substrate 20 further comprises a plurality of gate lines which are arranged in parallel on the second substrate 200, wherein the first pillow 21 is positioned above the gate lines, thereby making it easier to position the first pillow 21 and make it uniformly distributed in the alignment substrate 20.

Further, the second pillow 12 is also positioned above the black matrix, and the second photo spacer 22 is also positioned above the gate lines.

An embodiment of the present invention further provides a method for forming a photo spacer on a substrate, and the method comprises:

S01, forming a photo spacer layer on a substrate; and

S02, patterning the photo spacer layer so as to form a photo spacer, wherein a recess is formed on a first surface, which is spaced apart from the substrate, of the photo spacer.

It should be noted that, firstly, the substrate may be, for example, the above first substrate, and the photo spacer thus formed is the first photo spacer on the first substrate. Also the substrate may be the above second substrate, and the photo spacer thus formed is the second photo spacer on the second substrate.

Secondly, in the above step S02, the patterning process may be a process of performing any treatment on a film layer (formed by one or more layers of films) to form a specific pattern. A typical patterning process is a process of applying a mask plate once, performing exposure, development and etching with a photoresist, as well as removing the photoresist.

Based on the above, considering that the photo spacer is made of a non-photosensitive material, the patterning process further relates to etching and the like so as to remove areas which do not require patterns. Thus, in an embodiment, the photo spacer layer may be made of a positive/negative photoresist material.

Here, the so-called positive photoresist material refers to such a photoresist material: the photoresist material does not dissolve in a developing solution before exposure, but is transformed into a material capable of dissolving in the developing solution in an area exposed by ultraviolet rays, thus obtaining a photoresist with a predetermined pattern. A photosensitive characteristic of the negative photoresist material is just the opposite, that is, the negative photoresist material can dissolve in the developing solution before exposure, but is transformed into a material incapable of dissolving in the developing solution in an area exposed by ultraviolet rays, that is, capable of dissolving in the developing solution in other areas, thus obtaining a photoresist with a predetermined pattern.

Based on this, the above step S02 may be completed specifically with the following step:

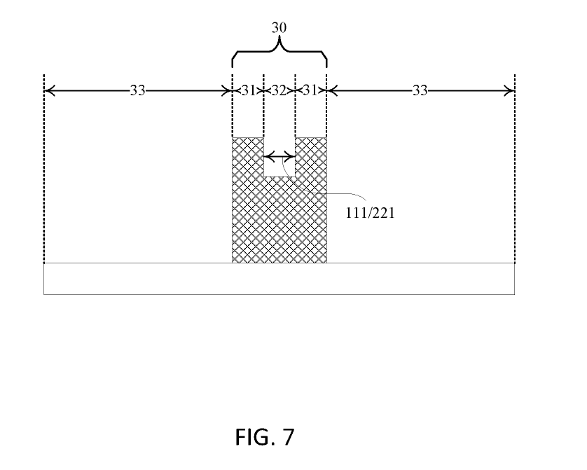

as shown in FIG. 7, performing exposure and development on the substrate on which the photo spacer layer is formed by adopting a half-tone mask plate or gray-tone mask plate, so as to form a photo spacer fully-reserved portion 31, a photo spacer half-reserved portion 32 and a photo spacer fully-removed portion 33. The photo spacer fully-reserved portion 31 and the photo spacer half-reserved portion 32 form the photo spacer 30.

The thickness of the photo spacer fully-reserved portion 31 is greater than that of the photo spacer half-reserved portion 32. The photo spacer half-reserved portion 32 corresponds to a first area, which is covered by the recess 111/221, in the photo spacer 30 to be formed, the photo spacer fully-reserved portion 31 corresponds to other area in the photo spacer 30 to be formed except for the first area, and the space fully-removed portion 33 corresponds to other area in the photo spacer layer except for the photo spacer 30 to be formed.

It should be noted that, for a better understanding of the above method provided by the embodiment of the present invention by those skilled in the art, the photo spacer 30 formed in the above step S02 in FIG. 7 is the first photo spacer 11 or second photo spacer 22 in the above described embodiment of the present invention. Correspondingly, the recess is the first recess 111 or second recess 221 in the first photo spacer 11 or second photo spacer 22, but the embodiment of the present invention is not limited to this.

It should be noted that, all drawings of the present invention are simplified schematic views of the above display substrate, the above alignment substrate, and the above display panel comprising the display substrate and/or the alignment substrate, which are merely used for clearly describing structures related to innovative aspects. Other structures irrelevant to the innovative aspects are existing structures, and are not embodied or only partially embodied in the drawings.

The above is merely detailed description of the present invention, and not intended to limit the protective scope of the present invention. Numerous modifications and changes will readily occur to those skilled in the art within the technical scope disclosed by the present invention. All these changes or substitutions should all be embraced within the protective scope of the present invention. Thus, the protective scope of the present invention should be interpreted solely in light of the accompanying claims.

1. A display substrate, comprising a first substrate, wherein
said display substrate further comprises a first photo spacer disposed on one side of the first substrate, and a first recess is disposed on a first surface, which is spaced apart from said first substrate, of said first photo spacer, said first recess allowing one end, which faces said first photo spacer, of a first pillow to extend into said first recess, wherein said first pillow is positioned on a second substrate in an alignment substrate aligned with said display substrate, and wherein
said display substrate is a color film substrate, and said alignment substrate is an array substrate,
said display substrate further comprises a black matrix positioned on said first substrate, wherein said first photo spacer is positioned above said black matrix, and
said alignment substrate further comprises a plurality of gate lines arranged in parallel on said second substrate, wherein said first pillow is positioned above said gate lines.

2. The display substrate according to claim 1, wherein
said display substrate further comprises a second pillow positioned on the same side of said first substrate as said first photo spacer, said second pillow allowing one end thereof, which faces a second photo spacer, to extend into a second recess, wherein said second photo spacer is positioned on said second substrate, and said second recess is disposed on a first surface, which is spaced apart from said second substrate, of said second photo spacer.

3. The display substrate according to claim 1, wherein
said first photo spacer is a post photo spacer.

4. (canceled)

5. A display panel, wherein
said display panel comprises the display substrate according to claim 1, as well as an alignment substrate aligned with said display substrate, wherein
said alignment substrate comprises a second substrate, as well as a first pillow disposed on one side, which faces said display substrate, of said second substrate, wherein one end, which faces the first photo spacer, of the first pillow, is positioned in the first recess, and wherein
said display substrate is a color film substrate, and said alignment substrate is an array substrate,
said display substrate further comprises a black matrix positioned on said first substrate, wherein said first photo spacer is positioned above said black matrix, and
said alignment substrate further comprises a plurality of gate lines arranged in parallel on said second substrate, wherein said first pillow is positioned above said gate lines.

6. The display panel according to claim 5, wherein along a direction perpendicular to the panel surface of said display panel,
the depth of said first recess is less than the height of said first pillow.

7. The display panel according to claim 5, wherein
said display panel further comprises a second pillow positioned on the same side of the first substrate as said first photo spacer, and said alignment substrate further comprises a second photo spacer positioned on the same side of the second substrate as said first pillow, wherein
a second recess is disposed on a first surface, which faces said second pillow, of said second photo spacer, and one end, which faces said second photo spacer, of said second pillow is positioned in said second recess.

8. The display panel according to claim 7, wherein along a direction perpendicular to the panel surface of said display panel,
the depth of said second recess is less than the height of said second pillow.

9. The display panel according to claim 7, wherein
said second photo spacer is a post photo spacer.

10-11. (canceled)

12. The display panel according to claim 5, wherein
said second pillow is positioned above said black matrix, and said second photo spacer is positioned above said gate lines.

13-14. (canceled)

15. The display substrate according to claim 2, wherein
said first photo spacer is a post photo spacer.

16. The display panel according to claim 8, wherein
said second photo spacer is a post photo spacer.
